(19) United States
(12) Patent Application Publication
(10) Pub. No.: US 2008/0038614 A1
(43) Pub. Date: Feb. 14, 2008

(54) Proton-conducting electrolyte membrane, production process thereof, and membrane-electrode assembly and fuel cell using the same

(75) Inventors: Satoshi Nakazawa, Hitachi-shi (JP); Takeo Yamaguchi, Tokyo (JP); Nobuo Hara, Tokyo (JP)

Correspondence Address: NIXON PEABODY, LLP, 401 9TH STREET, NW, SUITE 900, WASHINGTON, DC, 20004-2128, US

(73) Assignee: THE UNIVERSITY OF TOKYO

(21) Appl. No.: 11/706,364

(22) Filed: Feb. 15, 2007

(30) Foreign Application Priority Data
Aug. 9, 2006 (JP) 2006-216970
Feb. 9, 2007 (JP) 2007-030855

(51) Int. Cl. H01M 8/10

(52) U.S. Cl. 429/30; 521/50

(57) ABSTRACT

The present invention provides an electrolyte membrane capable of inhibiting permeation of water, methanol or other electrolyte solutions, permeation of hydrogen and oxygen gas, and swelling caused by electrolyte solution, and having superior mechanical strength, a production process thereof and a membrane-electrode assembly and fuel cell using that electrolyte membrane. The electrolyte membrane has a porous base material having a plurality of pores, and a proton-conducting polymer composition retained in said pores, wherein the proton-conducting polymer composition contains an aromatic hydrocarbon resin having protonic acid groups, free water contained in the electrolyte membrane at 25° C. is present at 0.5 molecules or less per each of the protonic acid groups, bound water contained in the electrolyte membrane at 25° C. is present at 1 molecule or less for each of the protonic acid groups, proton conductivity of the electrolyte membrane in water at 25° C. is 0.001 S/cm or more, and methanol permeability of the electrolyte membrane in 30% by weight methanol at 25° C. is 50 (kg·μm/m²·h) or less.

### BACKGROUND OF THE INVENTION

1. Field of the Invention

The present invention relates to an electrolyte membrane having a porous base material that has a plurality of pores and a proton-conducting polymer composition retained in the pores. More particularly, the present invention relates to an electrolyte membrane used in a fuel cell.

2. Description of the Related Art

Fuel cells are attracting attention as a clean power source for electric motors in reflection of depleting petroleum resources and the growing seriousness of global warming and other environmental problems. Fuel cells are characterized by low-temperature operation, high output density and compact size, and are considered to be important in view of their suitability to vehicle-mounted power supplies, home-use power supplies and other applications.

A known example of a fuel cell is a solid polymer electrolyte membrane fuel cell, which uses a proton-conducting polymer composition, such as the Nafion® perfluorocarbon-based polymer having sulfonic acid groups, for the electrolyte membrane. This electrolyte membrane is required to have a thin membrane thickness to reduce electrical resistance.

However, when the thickness of the electrolyte membrane of the above-mentioned polymer having sulfonic acid groups is attempted to be reduced, it was not possible to maintain suitable mechanical strength due to poor processability and membrane handling. In addition, due to the significant effects of short-circuiting phenomena (cross-over) between the methanol of the anode and the oxidant of the cathode through the electrolyte membrane caused by swelling of the electrolyte membrane, the electrolyte membrane was susceptible to the occurrence of melting (creeping) caused by increases in temperature.

Another known method for reducing the thickness of an electrolyte membrane involves impregnating a perfluoro ionic exchange resin into a porous polytetrafluoroethylene film (Japanese Patent Publication No. H5-75835). However, although perfluoro ionic exchange resins are able to inhibit swelling with respect to methanol and water to a certain extent, they are inadequate with respect to inhibiting permeation of methanol, thereby resulting in problems with the output characteristics of the electrolyte membrane.

However, according to H. Hatakeyama and T. Hatakeyama, Thermochemica Acta 308, (1998) pp. 3 to 22 and M. A. Hickner and B. S. Picovar, “Fuel Cells” (2005), 5, No. 2, pp. 213 to 299, the states of water contained in the water in the electrolyte film consisting of free water, bound water and non-freezing water are defined in the manner indicated below.

Free water: Water that has melting and freezing temperatures and enthalpy that are the same as bulk water without being affected by the electrolyte or base material.

Bound water: Water that has melting and freezing temperatures that differ from bulk water, interacts with the electrolyte of base material, and exhibits a phase transition (crystallization) at a temperature of −20 to 20° C.

Non-freezing water: Water that has melting and freezing temperatures that differ from bulk water, interacts strongly with the electrolyte or base material, and does not exhibit a phase transition (crystallization) at a temperature of −20 to 20° C., namely exhibits a phase transition (crystallization) at a temperature below −20° C.

Since free water, which is the same as bulk water, is able to migrate freely within an electrolyte, it causes a medium to induce permeation of methanol. In addition, bound water also causes permeation of methanol although not to the extent of free water. Consequently, the water contained in an electrolyte is ideally composed entirely of non-freezing water that interacts strongly with the electrolyte or base material.

Japanese Patent Application Laid-open No. 2005-19055 states that the amounts of free water and bound water can be reduced by mixing a proton-conducting polymer and a different polymer there from. However, since the amounts of free water and bound water were unable to be sufficiently reduced, the effect of preventing permeation of methanol was inadequate.

### SUMMARY OF THE INVENTION

A first object of the present invention is to provide an electrolyte membrane capable of inhibiting permeation of electrolyte solutions such as water and methanol, permeation of hydrogen and oxygen gas and swelling caused by electrolyte solution while also having superior mechanical strength, and a production process thereof.

A second object of the present invention is to provide an electrolyte membrane capable of realizing a greater reduction in thickness than that of conventional electrolyte membranes, having low electrical resistance and having superior dimensional stability, heat resistance and chemical resistance, and a production process thereof.

A third object of the present invention is to provide a membrane-electrode assembly using the above-mentioned electrolyte membrane.

A fourth object of the present invention is to provide a fuel cell using the above-mentioned membrane-electrode assembly.

As a result of conducting extensive studies to solve the above-mentioned problems, the inventors of the present invention found that a superior electrolyte membrane that overcomes the above-mentioned problems can be provided by retaining a proton-conducting polymer composition containing an aromatic hydrocarbon resin having protonic acid groups in all of a portion of the pores of a porous base material having a plurality of pores, thereby leading to completion of the present invention.

Namely, the present invention relates to that indicated below.

[1] An electrolyte membrane having: a porous base material having a plurality of pores; and a proton-conducting polymer composition retained in the pores, wherein the proton-conducting polymer composition contains an aromatic hydrocarbon resin having protonic acid groups, free water contained in the electrolyte membrane at 25° C. is present at 0.5 molecules or less per each of the protonic acid groups, bound water contained in the electrolyte membrane at 25° C. is present at 1 molecule or less for each of the protonic acid groups, proton conductivity of the electrolyte membrane in water at 25° C. is 0.001 S/cm or more, and methanol permeability of the electrolyte membrane in 30% by weight methanol at 25° C. is 50 (kg·μm/m²·h) or less.

### [2] The electrolyte membrane of above, wherein the aromatic hydrocarbon resin is selected from the group consisting of polysulfone, polyethersulfone, polyarylate, polyamideimide, polyetherimide, polyimide, polyquinoline and polyquinoxaline,

### [3] The electrolyte membrane of [1] above, wherein the aromatic hydrocarbon resin is polyethersulfone.

### [4] The electrolyte membrane of any of [1] to [3] above, wherein the protonic acid groups are selected from the group consisting of sulfonic acid groups, carboxylic acid groups, phosphoric acid groups and phenolic hydroxyl groups.

### [5] The electrolyte membrane of [1] above, wherein the aromatic hydrocarbon resin contains the structure represented by general formula (I):

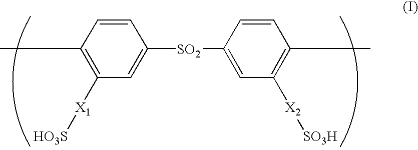

(wherein, X₁ and X₂ may be mutually the same or different, and represent —(ROₘ)ₙ—, and wherein R represents an alkylene group, m represents 0 or 1, and n represents an integer of 0 to 20).

### [6] The electrolyte membrane of [1] above, wherein the porous base material is an inorganic material or a heat-resistant polymer.

### [7] The electrolyte membrane of [1] above, wherein the porous base material is polyimide, and the aromatic hydrocarbon resin is polyethersulfone.

### [8] The electrolyte membrane of any of [1 to [7] above, wherein the proton-conducting polymer composition contains a crosslinking agent.

### [9] The electrolyte membrane of any of [1] to [8] above, wherein a portion of the pores and a portion of the aromatic hydrocarbon resin are immobilized.

[10] A process for producing the electrolyte membrane of [1] above having a porous base material having a plurality of pores and a proton-conducting polymer composition retained in said pores, comprising the steps of:

(1) retaining a monomer and/or oligomer for forming the proton-conducting polymer composition in the pores of the porous base material; and

(2) polymerizing the monomer and/or the oligomer in the pores.

### [11] The process for producing an electrolyte membrane of [10] above, wherein the monomer and/or oligomer for forming the proton-conducting polymer composition has three or more reactive groups.

[12]A process for producing the electrolyte membrane of [1] above having: a porous base material having a plurality of pores; and a proton-conducting polymer composition retained in said pores, the process comprising the steps of:

(1) introducing the proton-conducting polymer composition into the pores of the porous base material by immersing the porous base material in a solvent solution of the proton-conducting polymer composition; and

(2) holding the porous base material retaining the proton-conducting polymer composition at a temperature of 60° C. or higher for at least 1 hour.

### [13] A membrane-electrode assembly using the electrolyte membrane of any of [1 to [9] above.

### 14] A fuel cell using the membrane-electrode assembly of [13] above.

The electrolyte membrane of the present invention has low electrical resistance and is able to lower the internal resistance of a fuel cell in the case of using in a fuel cell. In addition, since the electrolyte membrane of the present invention has a proton-conducting polymer composition completely filled into the deepest portions of the pores of a porous base material, permeability of oxidizing gas (such as oxygen) of the cathode or methanol of the anode is extremely low. Moreover, since the electrolyte membrane of the present invention is able to use as a parent material a porous base material having superior dimensional stability, heat resistance and chemical resistance, an electrolyte membrane of stable quality can be provided that is capable of inhibiting swelling of the electrolyte even under high-temperature conditions and inhibiting permeation of methanol and oxygen gas. In addition, since there is no decomposition of hydrogen peroxide and so on generated within the electrolyte to radical compounds and so on, a high cell output can be stably obtained over a long period of time.

The electrolyte membrane of the present invention is used as an electrolyte membrane for use in fuel cells, and particularly solid polymer fuel cells and direct methanol fuel cells. As a result of using in such fuel cells, crossover of fuel such as methanol and oxidant such as O₂ gas can be inhibited, thereby allowing the obtaining of stable, high cell output for a long period of time.

The water contained in the electrolyte membrane of the present invention is composed of water that interacts with the electrolyte or base material (bound water or non-freezing water), with the majority consisting of non-freezing water with hardly any free water present, and the amount of bound water being as low as possible. As a result of employing this type of structure, the electrolyte composed entirely of non-freezing water that strongly interacts with the electrolyte or base material is resistant to the formation of so-called clusters in which water surrounds sulfonic acid groups. Consequently, the migration of water can be inhibited as much as possible, and permeability of methanol and oxygen gas can be inhibited. Moreover, since the infiltration of radical compounds such as hydrogen peroxide generated within the electrolyte can be inhibited, a high cell output can be stably obtained for a long period of time.

### BRIEF DESCRIPTION OF THE DRAWINGS

FIG. 1 shows measurement charts of low-temperature DSC in Examples 1 and 2 and Comparative Examples 1 to 3;

FIG. 2 is a graph showing the relationship between filling rate and water content;

FIG. 3 is a graph showing the relationship between filling rate and bound water;

FIG. 4 is a graph showing the relationship between filling rate and non-freezing water;

FIG. 5 is a graph showing the relationship between filling rate and sulfonic acid group density;

FIG. 6 is a graph showing the relationship between proton conductivity and sulfonic acid group density; and

FIG. 7 is a graph showing the relationship between proton conductivity, sulfonic acid group density and non-freezing water.

### DESCRIPTION OF THE PREFERRED EMBODIMENTS

The following provides a detailed description of the electrolyte membrane of the present invention, the production process thereof, and a membrane-electrode assembly and fuel cell.

### (1) Electrolyte Membrane

The electrolyte membrane of the present invention has a porous base material having a plurality of pores, and a proton-conducting polymer composition retained within the pores. Electrolyte membranes are preferred to have superior proton conductivity dimensional stability, heat resistance and chemical resistance. A preferable combination of the porous base material and the proton-conducting polymer composition is such that both are materials containing aromatic groups.

Here, the proton conductivity of the electrolyte membrane is preferably 0.001 S/cm or more and more preferably 0.002 S/cm or more at a temperature of 25° C. and humidity of 100%.

Methanol permeability in 30% by weight methanol at 25° C. is 0 to 100 (kg·μm/m²·h) and preferably 0 to 50 (kg·μm/m²·h). If the methanol permeability is or exceeds 100 (kg·μm/m²·h), deterioration of performance attributable to permeation of methanol becomes prominent.

Since swelling of the electrolyte can be inhibited even under high-temperature conditions, dimensional stability and heat resistance are preferable with respect to being able to inhibit permeation of methanol and oxygen gas.

Dimensional stability is preferably 20% or less, more preferably 10% or less and even more preferably 3% or less in terms of the rate of change in surface area (%) before and after immersion for 24 hours in pure water at 25° C. If the rate of change in surface area is 20% or less, adequate adhesion is obtained between the electrolyte membrane surface and catalyst layer, swelling of the electrolyte can be adequately inhibited without the interface resistance between the electrolyte membrane and catalyst layer becoming excessively large, and methanol permeability can be held to a low level.

Heat resistance is preferably such that physical properties do not change within the working temperature range of the fuel cell of −30 to 150° C.

Chemical resistance is preferably such that the electrolyte membrane has a high degree of oxidation resistance that prevents decomposition of hydrogen peroxide and so on generated within the electrolyte membrane to oxidants.

### (1-1) Porous Base Material

There are no particular limitations on the porous base material used in the present invention, and a known inorganic material or organic material can be selected. These porous base materials preferably have superior dimensional stability, heat resistance, chemical resistance and mechanical strength.

Specific examples of inorganic materials include alumina-based, zirconia-based, silica-based, silicon nitride-based and silicon carbide-based ceramics, glass, alumina and composites thereof. In addition, various types of polymers such as thermosetting resins and thermoplastic resins can be selected for the organic material. The porous base material is preferably an organic material containing an aromatic group. In addition, a heat-resistant polymer is preferable in terms of durability. Here, a heat-resistant polymer refers to a resin having a glass transition temperature (Tg) of 150° C. or higher and preferably 150 to 300° C. Preferable examples of heat-resistant polymers include polysulfone, polyethersulfone, polyarylate, polyamideimide, polyetherimide, polyimide, polyquinoline, polyquinoxaline, cross linked polyethylene and mixtures thereof. Here, the polyquinoline and polyquinoxaline refer to polymers having the quinoline backbone and quinoxaline backbone indicated below.

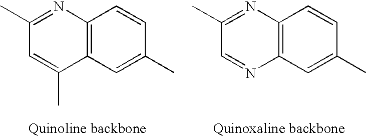

The film thickness of the porous base material used in the present invention is, for example, 0.01 to 300 μm, preferably 0.01 to 200 μm and more preferably 0.1 to 100 μm. If the film thickness is 0.01 μm or more, adequate strength is obtained and the porous base material is advantageous in terms of handling and workability. A film thickness is 300 μm or less is preferable since the electrical resistance of the resulting electrolyte membrane does not become excessively large. In addition, since the porous base material of the present invention does not require the introduction of sulfonic acid groups for imparting proton conductivity, it is not subjected to the effect of the sulfonic acid groups causing a decrease in mechanical strength of the membrane. Thus, the film thickness of the porous base material of the present invention is, for example, less than 20 μm preferably 10 μm or less, and more preferably 1 μm or less.

The pores present in the porous base material in which the proton-conducting polymer composition is retained are suitably continuous pores. Here, “continuous pores” refers to pores penetrating both the top surface and back surface of the porous base material, and as a result of retaining the proton-conducting polymer composition in such continuous pores, the protons are able to migrate from the top surface to the back surface of the porous base material through the continuous pores. Thus, the porous base material of the present invention enables protons to migrate through the continuous pores without being swollen by the electrolyte.

The porosity of the porous base material of the present invention is suitably, for example, 10 to 95%, preferably 20 to 90% and more preferably 40 to 80%. If the porosity is 10% or more, the proton-conducting polymer composition can be adequately retained in the pores of the porous base material, and adequate ion conductivity can be obtained. In addition, if the porosity is 95% or less, practical thin film strength can be obtained.

The mean diameter of the pores penetrating the top surface and back surface of the porous base material used in the present invention (mean penetrating pore diameter) is suitably 0.001 to 100 μm, preferably 0.005 to 50 μm and more preferably 0.01 to 10 μm. If the mean penetrating pore diameter is 0.001 μm or more, the proton-conducting polymer composition can be adequately retained in the pores of the porous base material, and adequate ion conductivity can be obtained. In addition, if the mean penetrating pore diameter is 100 μm or less, the proton-conducting polymer composition can be immobilized within the pores without leaking out.

### (1-2) Proton-Conducting Polymer Composition

The proton-conducting polymer composition used in the present invention contains an aromatic hydrocarbon resin having protonic acid groups, and as necessary, other resins and additives.

### (1-2-1) Aromatic Hydrocarbon Resin

The aromatic hydrocarbon resin used in the present invention has aromatic groups in the main backbone of a hydrocarbon resin. This aromatic hydrocarbon resin is preferable with respect to heat resistance, oxidation resistance, flexibility and film deposition. Suitable examples of the main backbone of this aromatic hydrocarbon resin include polyetherketone, polysulfide, polyphosphagen, polyphenylene, polybenzoimidazole, polyethersulfone, polyphenylene oxide, polycarbonate, polyurethane, polyamide, polyimide, polyurea, polyquinoline, polyquinoxaline, polysulfone, polysulfonate, polybenzoxazole, polybenzothiazole, polythiazole, polyphenylquinoxaline, polyquinoline, polysiloxane, polytriazine, polydiene, polypyridine, polypyrimidine, polyoxathiazole, polytetrazapyrene, polyoxazole, polyvinylpyridine, polyvinylimidazole, polypyrrolidone, polyacrylate derivatives, polymethacrylate derivatives and polystyrene derivatives. In particular, polysulfone, polyethersulfone, polyarylate, polyamideimide, polyetherimide, polyimide, polyquinoline or polyquinoxaline is contained preferably, while polyethersulfone is contained particularly preferably, with respect to heat resistance and electrolyte resistance (swelling resistance). The aromatic hydrocarbon resin may be a mixture of one or a plurality of types of the above-mentioned polymers, or may be a copolymer obtained by copolymerizing one or a plurality of monomers that compose the above-mentioned polymers.

The number average molecular weight of the aromatic hydrocarbon resin used in the present invention is preferably 1,000 to 1,000,000, and from the viewpoint of strength and processability of the resulting electrolyte membrane, is more preferably 5,000 to 500,000 and particularly preferably 10,000 to 200,000. If the number average molecular weight is 1,000 or more, the strength of the resulting electrolyte membrane can be adequately maintained, and if the number average molecular weight is 1,000,000 or less, adequate processability can be retained.

### (1-2-2) Protonic Acid Groups

Examples of protonic acid groups present in the aromatic hydrocarbon resin include functional groups that easily release protons, and for example, at least one type thereof is contained that is selected from the group consisting of sulfonic acid groups (—SO₃H), carboxylic acid groups (—COOH), phosphoric acid groups (—PO₃H₂), alkylsulfonic acid groups (—(CH₂)ₙSO₃H), alkylcarboxylic acid groups (—(CH₂)ₙCOOH), alkylphosphonic acid groups (—(CH₂)ₙPO₃H₂) and phenolic hydroxyl groups (-Ph-OH) (wherein, n is, for example, 1 to 10 and preferably 1 to 5). A portion of the above-mentioned sulfonic acid groups, carboxylic acid groups and phosphoric acid groups may be substituted with an alkyl group, sodium, potassium or calcium and soon. The alkyl groups and alkylene groups contained in the above-mentioned acid forming groups contain 1 to 10 carbon atoms and preferably 1 to 5 carbon atoms.

Various known reactions for introducing functional groups can be used to introduce the protonic acid groups into the aromatic hydrocarbon resin. For example, a sulfonating agent is used in the case of introducing sulfonic acid groups. There are no particular limitations on this sulfonating agent, and examples of sulfonating agents that can be used preferably include concentrated sulfuric acid, fuming sulfuric acid, chlorosulfuric acid and anhydrous sulfuric acid complex. In addition, an oxidation reaction, carboxylic acid derivative hydrolysis reaction or transfer reaction and so on can be used in the case of introducing carboxylic acid groups. A halogen or other substitution reaction, quinone or other reduction reaction or hydrocarbon oxidation reaction and so on can be used in the case of introducing phenolic hydroxyl groups.

In addition, introduction of protonic acid groups into the main backbone of the aromatic hydrocarbon resin preferably consists of introducing protonic acid groups into a monomer for producing the aromatic hydrocarbon resin prior to polymerization of the aromatic hydrocarbon resin. As a result of introducing protonic acid groups at the monomer stage, satisfactory oxidation resistance is obtained as a result of the sulfonic acid groups being uniformly introduced into the polymer chain, thereby facilitating control of proton conductivity and enabling the production of an electrolyte membrane of uniform quality. In addition, introduction of protonic acid groups is easier than in the case of introducing into a polymer.

Protonic acid groups are contained at, for example, 0.1 to 5 groups, preferably 0.5 to 4 groups, and more preferably 1 to 2 groups per unit backbone that composes the aromatic hydrocarbon resin. Further, mole number of protonic acid groups included in 1 cm³ of the pore (hole) of the porous base material (density of protonic acid groups (mmol/cm³)) is desirably 0.5 to 1.5 mmol/cm³ preferably 0.7 to 1.2 mmol/cm³, more preferably 0.8 to 1.1 mol/cm³. The density of protonic acid groups can be obtained by the following formula.

[Density of Protonic acid groups(mmol/cm³)]=[Volume density of Filled polymer(g/cm³)]×[Ion change capacity IEC(meq)]

wherein the volume density of filled polymer (g/cm³) means the mass (g) of the filled polymer per 1 cm³ of the pore (hole) of the porous base material composed of the electrolyte membrane. Indeed, it can be calculated from the mass (g) of the polymer filled in the pore(s) which has (have) a volume of [1 cm×1 cm×(the film thickness of the filled polymer (cm))×(the porosity after the polymer was filled)].

### (1-2-3) Aromatic Hydrocarbon Resin Having Protonic Acid Groups

A preferable aromatic hydrocarbon resin having protonic acid groups of the present invention has a structure represented by general formula (I) shown below.

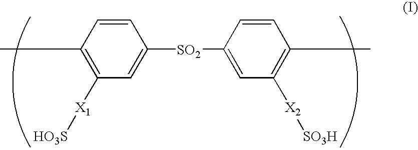

In general formula (I), X₁ and X₂ may be mutually the same or different and represent —(ROₘ)ₙ—. Here, R represents an alkylene group, and preferably a linear or branched alkylene group having 1 to 20 carbon atoms, and more preferably a linear or branched alkylene group having 1 to 10 carbon atoms, m is 0 or 1, and n is an integer of 0 to 20, preferably 0 to 10 and more preferably 1 to 5. The above-mentioned alkylene group represented by R may be partially substituted with a halogen group, hydroxyl group or phenol and so on.

In addition, a preferable aromatic hydrocarbon resin having protonic acid groups of the present invention may have the structure of a divalent ether group represented by general formula (II) below.

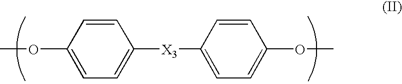

In general formula (II), X₃ represents a single bond, —O—, —SO₂—, —CO—,

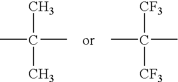

Moreover, a preferable aromatic hydrocarbon resin having protonic acid groups of the present invention may have the structure of a group obtained from a monomer/oligomer having three or more reactive groups represented by general formula (III) below.

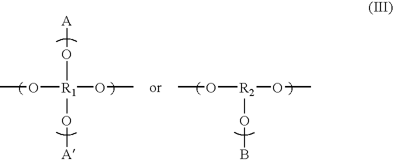

In general formula (III), R₁ and R₂ represent groups consisting of C, H and O (namely, divalent hydrocarbon groups). The molecular weight of the groups represented by the general formula (III) is suitably, for example, 1,000 or less and preferably 100 to 500. Specific examples of R₁ and R₂ include substituents in which 3 or 4 hydrogen groups have been eliminated from a compound selected from the group consisting of benzophenone, flavone, anthraquinone, pyridine and R₃(Ph-)ₙ (wherein, R₃ represents a saturated or unsaturated, linear or branched 1-100 C aliphatic group, cyclic group or aromatic group, and n is 3 or 4). More preferably, R₂ represents a CH₃C(Ph-)₃ group.

The groups represented by the above-mentioned general formula (III) have crosslinking sites at positions A, A′ and B. The groups represented by the general formula (III) can be crosslinked with the resin or porous base material contained in the electrolyte membrane of the present invention. As a result of this crosslinking, ether bonds, ester bonds, amide bonds, sulfone bonds, urea bonds, imide bonds, carbonyl bonds or quinoxaline bonds can be formed.

A typical example of a method for synthesizing this aromatic hydrocarbon resin having protonic acid groups is the polyethersulfone synthesis method of MacGrath, et al. (James E. MacGrath, et al., “Direct polymerization of sulfonated poly (arylene ether sulfone) random (statistical) copolymers: Candidates for new proton exchange membranes”, Journal of Membrane Science 197 (2002), pp. 231 to 242). Namely, using 3,3′-sodium disulfonate-4,4′-dichlorodiphenylsulfone (4,4′-dihydroxy-3,3′-disulfonic acid diphenylsulfone sodium salt) and 4,4′-dichlorodiphenylsulfone (bis(4-chlorophenyl)sulfone) as halogen group-containing monomers, these monomers are reacted with a hydroxyl group-containing monomer such as 4,4′-dihydroxybiphenyl to synthesize an aromatic hydrocarbon resin having protonic acid groups. In this synthesis method, an aprotic polar solvent such as N-methyl-2-pyrrolidine N,N-dimethylacetoamide, N,N-dimethylformamide, dimethylsulfoxide or hexamethyl phosphonamide is used in the reaction solution. In addition, a base such as potassium carbonate, sodium carbonate, potassium bicarbonate, sodium bicarbonate, sodium hydroxide or potassium hydroxide is used as a reaction catalyst. In addition, in addition to the above-mentioned monomers, examples of other halogen group-containing monomers include sulfonic acid group-containing 4,4′-dichlorodiphenylsulfone, sulfonic acid group-containing 4,4′-difluorodiphenylsulfone, sulfonic acid group-containing 4,4′-dichlorobenzophenone, sulfonic acid group-containing 4,4′-difluorobenzophenone, sulfonic acid group-containing 1,3-dichloronaphthalene, sulfonic acid group-containing 1,3-difluoronaphthalene, sulfonic acid group-containing 1,5-dichloronaphthalene, sulfonic acid group-containing 1,5-difluoronaphthalene, 4,4′-difluorodiphenylsulfone, 4,4′-dichlorobenzophenone, 4,4′-difluorobenzophenone, 1,3-dichloronaphthalene, 1,3-difluoronaphthalene, 1,5-dichloronaphthalene and 1,5-difluoronaphthalene. In addition, examples of hydroxyl group-containing monomers include 4,4′-dihydroxydiphenylether, 4,4′-dihydroxydiphenylthioether, 4,4′-dihydroxydiphenylsulfone, 4,4′-dihydroxydiphenylketone, 4,4′-dihydroxybenzophenone, 1,3-dihydroxynaphthalene and 1,5-dihydroxynaphthalene.

### (1-2-4) Other Resins

Although the proton-conducting polymer composition used in the present invention may be a polymer resin comprised only of one type of the above-mentioned aromatic hydrocarbon resin, one or more types of resins other than the aromatic hydrocarbon resin may also be contained within a range that does not significantly decrease the characteristics of the proton-conducting polymer composition used in the present invention. As a result of adding these resins, plasticity can be added to the proton-conducting resin composition.

In addition, the effect of preventing the proton-conducting polymer composition to be retained in the pores of the porous base material that inhibits electrolyte swelling from precipitating (eluting) outside the pores is obtained.

Specific examples of such other resins include general-purpose resins such as polyethylene (PE), polypropylene (PP), polystyrene (PS), polymethyl methacrylate (PMMA), ABS resin and AS resin; engineering plastics such as polyacetate (POM), polycarbonate (PC), polyamide (PA: Nylon), polyethylene terephthalate (PET) and polybutylene terephthalate (PBT); thermoplastic resins such as polyacrylonitrile, polyacrylic acid, polyphenylene sulfide (PPS), polyethersulfone (PES), polyketone (PK), polyimide (PI), polycyclohexane dimethanol terephthalate (PCT), polyarylate (PAR), and various types of liquid crystal polymers (LCP); and, thermosetting resins such as epoxy resin, phenol resin, Novolak resin and bismaleimide resin. In addition, the other resins referred to here may have a structure having crosslinking sites able to bond with the resin or base material contained in the electrolyte membrane of the present invention.

The crosslinking sites are preferably reactive groups capable of forming ether bonds, ester bonds, amide bonds, sulfone bonds, urea bonds, imide bonds, carbonyl bonds or quinoxaline bonds.

The number average molecular weight of the other resins is preferably 1,000 to 1,000,000, and from the viewpoints of strength and processability of the resulting electrolyte membrane, more preferably 5,000 to 500,000 and particularly preferably 10,000 to 200,000. If the number average molecular weight is 1,000 or more, the strength of the resulting electrolyte membrane can be adequately maintained, and if the number average molecular weight is 1,000,000 or less, adequate processability can be maintained.

The other reins are preferably present in the proton-conducting polymer composition at, for example, 0.01 to 90% by weight and preferably 10 to 50% by weight. If the other resins are present at 0.01% by weight or more, effects of reducing electrolyte swelling and methanol permeability are adequately obtained, thereby making this preferable. If the other resins are present at 90% by weight or less, satisfactory proton conductivity is obtained, thereby making this preferable.

### (1-2-5) Other Additives

Various additives may be contained as necessary in the proton-conducting polymer composition used in the present intention, examples of which include an antioxidant, thermostabilizer, lubricant, tackifier, plasticizer, crosslinking agent, viscosity adjuster, antistatic agent, antibacterial agent, antifoaming agent or polymerization inhibitor. Examples of crosslinking agents in particular include epoxy resin, bismaleimide and acrylate resin.

These additives are added to the proton-conducting polymer composition at 0.01 to 50% by weight and preferably 0.1 to 30% by weight.

### (1-2-6) Composition of Proton-Conducting Polymer Composition

The composition of the proton-conducting polymer composition is such that it contains, for example, 50% by weight or more and preferably 70% by weight or more of the aromatic hydrocarbon resin having protonic acid groups with respect to the entire resin composition. If the amount of the aromatic hydrocarbon resin is 50% by weight or more, the protonic acid group concentration in the proton-containing polymer composition is adequately maintained, thereby allowing the obtaining of satisfactory proton conductivity. In addition, this is also preferable since the phase of the aromatic hydrocarbon resin having protonic acid groups does not become a discontinuous phase, and there is no decrease in mobility of the conducting protons.

### (1-2-7) Structure of Water Contained in Proton-Conducting Polymer Composition

The state of water contained in the electrolyte can be easily measured by DSC. When measurement is made by DSC by using for the sample the surface of the electrolyte membrane from which water has been wiped off after having been immersed in water at 25° C. for 24 hours, the sharp peak in the vicinity of 0° C. can be defined as indicating free water, the broad peak at −20 to 20° C. can be defined as indicating bound water, and water for which there is no peak observed can be defined as non-freezing water.

Among these, since free water is in the same state as bulk water and is not affected by the electrolyte or base material, it easily forms cluster structures that cause permeation of methanol and gas. In addition, although the migration of water molecules in bound water is inhibited to a certain extent, it also easily forms cluster structures that cause permeation of in ethanol and gas. Consequently, it is preferable to reduce the amounts of free water and bound water as much as possible, and preferable to contain only non-freezing water that strongly interacts with the electrolyte or base material. The content of free water (number of water molecules) is preferably 0 to 0.5 molecules and more preferably 0 to 0.1 molecules per protonic acid group contained in the electrolyte membrane. The amount of bond water is preferably 0 to 1 molecule, more preferably 0 to 0.5 molecules and even more preferably 0 to 0.1 molecules per protonic acid group contained in the electrolyte membrane.

The amount of non-freezing water is preferably 100 to 1 molecules, more preferably 30 to 2 molecules and even more preferably 20 to 4 molecules per protonic acid group contained in the electrolyte membrane. If the amount of non-freezing water is 1 molecule or less, proton conductivity is inadequate, while if the amount of non-freezing water is or exceeds 100 molecules, penetration of peroxides becomes easy, thereby causing the lifetime of the membrane to be shortened.

### (2) Electrolyte Membrane and Production Process Thereof

The electrolyte membrane of the present invention consists of introducing (filling, inserting) the proton-conducting polymer composition into the pores of the porous base material, and retaining (immobilizing, loading) the proton-conducting polymer composition in the pores of the porous base material.

### (2-1) Electrolyte Membrane Production Process

There are no particular limitations on the method used to introduce the proton-conducting polymer composition into the porous base material, and examples of such methods include (a) a method consisting of polymerizing a monomer and/or oligomer in the pores of the porous base material, and (b) a method consisting of introducing the proton-conducting polymer composition into the pores of the porous base material by impregnating the porous base material with a solvent solution of the proton-conducting polymer composition.

(a) Polymerization of Monomer and/or oligomer in Pores of Porous Base Material

The method for polymerizing a monomer and/or oligomer in the pores of the porous base material suitably comprises the steps of:

(1) retaining a monomer and/or oligomer for forming the proton-conducting polymer composition in the pores of the porous base material, and

(2) polymerizing the monomer and/or oligomer in the pores.

This polymerization method involves polymerizing the proton-conducting polymer composition within the pores of the porous base material, and the use of this method enables the proton-conducting polymer composition to crosslink with the insides of the pores of the porous base material, thereby making it possible to prevent precipitation (elution) of the proton-conducting polymer composition outside the pores.

Moreover, the proton-conducting polymer composition and the porous base material can be reacted during polymerization. For example, in the case of using for the proton-conducting polymer composition a polyethersulfone having hydroxyl groups for the reactive groups serving as crosslinking sites, and using a polyimide for the porous base material, the terminal hydroxyl groups of the polyethersulfone reacts with the unreacted polyamic acid in the polyimide porous base material, thereby enabling crosslinking by the formation of ester bonds. In this manner, as a result of crosslinking accompanying reaction between the pores and the proton-conducting polymer composition, the precipitation (elution) of the proton-conducting polymer composition outside the pores can be inhibited.

The monomer and/or oligomer used here suitably has three or more and preferably three or four reactive groups. Here, examples of reactive groups include hydroxyl groups and carboxyl groups.

In addition, ether bonds, ester bonds, amide bonds, sulfone bonds, urea bonds, imide bonds, carbonyl bonds or quinoxaline bonds are preferably formed as a result of crosslinking. The formation of ether bonds or ester bonds is particularly preferable.

Examples of this monomer include those having trifunctional or greater hydroxyl groups such as 1,1,1-tris(4-hydroxyphenyl) ethane, 1,3,5-tris(4-hydroxyphenyl)benzene, 2,4,4′-trihydroxybenzophenone, 2,3,4-trihydroxybenzophenone, 4′,5,7,-trihydroxyflavanone, 3,5,7-trihydroxyflavone, 4′,5,7-trihydroxyflavone, 5,6,7-trihydroxyflavone, 6-methyl-1,3,8-trihydroxyanthraquinone, 2,4,5-trihydroxypyridine and 2,2′,4,4′-tetrahydroxybenzophenone.

In addition, the oligomer contains 2 or more, and preferably 2 to 100, of the above-mentioned monomer molecules.

The amount of the monomer and/or oligomer having three or more reactive groups used is suitably, for example, 0.0001 to 80 mol %, preferably 0.001 to 50 mol % and more preferably 0.01 to 40 mol % of all of the monomers and/or oligomers used in the above-mentioned electrolyte membrane production process. If the amount used is 80 mol % or less, the resulting electrolyte membrane has adequate flexibility, and if the amount used is 0.0001 mol % or more, adequate effects are obtained as an electrolyte membrane, thereby making this preferable.

A specific reaction method first consists of retaining a monomer and/or oligomer for forming the proton-conducting polymer composition in the pores. Namely, a solution containing the monomer and/or oligomer is prepared, or a solution is prepared in which said monomer and/or oligomer is dissolved in a solvent, for forming the proton-conducting polymer composition of the present invention.

Here, examples of solvents that can be used include toluene, acetone, N-methyl-2-pyrrolidinone (NMP), dimethylformamide (DMF), dimethylsulfoxide (DMS) and dimethylacetoamide (DMAc). The porous base material is immersed in this monomer and/or oligomer, or a solvent solution in which they are contained, to retain the monomer and/or oligomer in the pores of the porous base material.

Next, the monomer and/or oligomer is polymerized in the pores. Ordinary conditions for polymerizing the monomer and/or oligomer can be used for the polymerization conditions. For example, the monomer and/or oligomer can be retained in the pores by preheating for 1 to 24 hours and preferably 2 to 12 hours at 60 to 200° C. and preferably 80 to 180° C., followed by further heating to a higher temperature of 150 to 250° C. and preferably 160 to 200° C., and further holding at that temperature for 8 to 64 hours and preferably 12 to 48 hours.

During polymerization, the pores of the porous base material are preferable sealed. Sealing the pores refers to preventing dispersion of solvent within the pores, and this sealing makes it difficult for the solvent to disperse and allows the solvent to be removed slowly by allowing time for the polymerization to proceed. In this sense, the sealing referred to here does not refer to sealing completely such that there is no dispersion of solvent whatsoever, but rather the state in which dispersion of the solvent is inhibited, for example, by at least 70%, preferably 80 to 99.9% and more preferably by 90 to 99% as compared with the state of being completely dispersed. Sealing is carried out by covering both surfaces of the porous base material with a non-porous polyimide or other resin film or with a glass substrate and so on.

Following completion of the polymerization reaction, the base material is rinsed with water followed by drying for 0.5 to 10 hours and preferably 1 to 5 hours at 40 to 120° C. and preferably 80 to 100° C. to remove the moisture and obtain a polymer.

(b) Introduction of Proton-Conducting Polymer Composition into Pores of Porous Base Material by Impregnating Porous Base

Material with Solvent Solution of Proton-Conducting Polymer Composition

A method for impregnating the porous base material with a solvent solution of the proton-conducting polymer composition suitably comprises the steps of:

(1) introducing the proton-conducting polymer composition into the pores of the porous base material by immersing the porous base material in a solvent solution of the proton-conducting polymer composition; and

(2) holding the porous base material retaining the proton-conducting polymer composition at a temperature of 60° C. or higher for at least 1 hour.

More specifically, the porous base material is first immersed in a solvent solution of the proton-conducting polymer composition. As a result, the proton-conducting polymer composition is introduced into the pores of the porous base material.

The resulting solvent solution suitably contains, for example, 5 to 50% by weight and preferably 10 to 40% by weight of the proton-conducting polymer composition. Examples of solvents that can be used include toluene, acetone, N-methyl-2-pyrrolidinone (NMP), dimethylformamide (DMF), dimethylsulfoxide (DMSO) and dimethylacetoamide (DMAc). The use of acetone is particularly preferable since impurities in the porous base material and in the solvent solution can be removed. Moreover, the porous base material is preferably immersed while degassing under reduced pressure during immersion of the porous base material. In addition, a crosslinking agent may be added to crosslink a portion of the pores and a portion of the proton-conducting polymer composition. An aromatic hydrocarbon resin containing bismaleimide, epoxy groups or acrylate is preferably used for the proton-conducting polymer composition in order to carry out crosslinking.

Next, the porous base material retaining the proton-conducting polymer composition is subjected to heat treatment. As a result of this heat treatment, the proton-conducting polymer composition is further introduced into the pores of the porous base material, solvent is removed, and the proton-conducting polymer composition is filled into and solidified within the pores.

The temperature of the heat treatment is suitably, for example, 60 to 200° C. and preferably 80 to 180° C. In addition, the duration of the heat treatment is suitably at least 1 hour, for example, 1 to 36 hours, preferably 1 to 30 hours and more preferably 2 to 24 hours. As a result of making the temperature of heat treatment 60° C. or higher, the proton-conducting polymer composition can be rapidly introduced into and solidified within the pores of the porous base material. In addition, if the duration of the heat treatment is 1 hour or more, the proton-conducting polymer composition adequately penetrates the pores of the porous base material, and if the duration of the heat treatment is 36 hours or less, there is no thermal decomposition of the porous base material.

The pores of the porous base material are preferably sealed during the above-mentioned heat treatment. Sealing the pores makes it difficult for the solvent to disperse and allows the solvent to be removed slowly by allowing time for the heat treatment to proceed. As a result of sealing the pores in this manner, there is no precipitation of the proton-conducting polymer composition on the surface of the porous base material, and a greater amount of the proton-conducting polymer composition is introduced into the pores of the porous base material. The sealing referred to here does not refer to sealing completely such that there is no dispersion of solvent whatsoever, but rather the state in which dispersion of the solvent is inhibited, for example, by at least 70%, preferably 80 to 99.9% and more preferably by 90 to 99% as compared with the state of the solvent being completely dispersed. Sealing is carried out by covering both surfaces of the porous base material with a non-porous polyimide or other resin film or with a glass substrate and so on.

An electrolyte membrane obtained in the manner described above can be subjected to known treatment such as washing, drying, sulfonation, chlorosulfonation, phosphonium treatment or hydrolysis as necessary to introduce desired cation exchange groups into the proton-conducting polymer composition in the electrolyte membrane and obtain a cation exchange resin.

### (2-2) Properties of Electrolyte Membrane

The resulting electrolyte membrane has the proton-conducting polymer composition retained in the pores of all or a portion of the porous base material. Retention refers to the state in which the proton-conducting polymer composition has entered the pores of the porous substrate and is unable to leave the pores without the pores and proton-conducting polymer composition being chemically bonded, while immobilization refers to the state of the proton-conducting polymer composition being immobilized in the pores as a result of chemical bonding between the pores and the proton-conducting polymer composition. The latter solidification includes the case in which the pores and the proton-conducting polymer composition are immobilized as a result of bonding between a portion of the pores of the porous base material, such as a portion of the functional groups of the polymer that composes the porous base material, and a portion of the aromatic hydrocarbon resin having protonic acid groups that composes the proton-conducting polymer composition, such as a portion of the functional groups of the polymer that composes the aromatic hydrocarbon resin.

Although the resulting electrolyte membrane can have an arbitrary thickness according to the purpose of use, it is preferably as thin as possible in terms of proton conductivity. More specifically, the thickness of the electrolyte membrane in terms of the dry film thickness is, for example, 5 to 200 μm, preferably 5 to 75 μm and more preferably 5 to 50 μm. If the thickness of the electrolyte membrane is 5 μm or more, the electrolyte membrane is easy to handle, and the problem of short-circuiting of a fuel cell using this electrolyte membrane can be avoided. If the thickness of the electrolyte membrane is 200 μm or less, the electrical resistance of the electrolyte membrane can be held to a low value, and the power generation performance of a fuel cell using this electrolyte membrane can be favorably improved. In addition, a layer of a proton-conducting polymer composition may also be further laminated on the surface of the electrolyte membrane of the present invention.

In the case the electrical conductivity of the electrolyte membrane of the present invention is high, a surface layer having a thickness of several microns can also be removed by carrying out grinding or sandblasting on both sides of the membrane. This grinding of the membrane or removal of a surface layer also contributes to improved adhesion when adhering an electrode catalyst layer on the electrolyte membrane of the present invention.

The cross-section of the electrolyte membrane of the present invention may be heterogeneous in order to reduce the electrical resistance of the membrane. Namely, only one of the surfaces of the membrane may be a porous film having a dense structure in the manner of a reverse osmosis membrane (having porosity of 10 to 60% and preferably 20 to 50%, and a mean pore diameter of 0.001 to 10 μm and preferably 0.01 to 5 μm), while the inside and opposite surface may be porous (having porosity of 30 to 90% and preferably 40 to 80%, and a mean pore diameter of 0.01 to 100 μm and preferably 0.1 to 5 μm). A particularly preferable structure of the electrolyte membrane of the present invention when used as a reverse osmosis membrane consists of a dense structure as described above for both surfaces of the membrane, with the internal portion being porous in the manner described above.

The electrolyte membrane of the present invention preferably contains an adequate amount of the proton-conducting polymer composition in the porous base material. The amount of the proton-conducting polymer composition contained in the porous base material can be evaluated in terms of the filling rate. The filling rate refers to the weight ratio of the proton-conducting polymer composition filled into the porous base material, and can be determined with the following equation:

[Filling rate]=[Percent by weight of proton-conducting polymer composition actually filled]/[Percent by weight of proton-conducting polymer composition in the case of being theoretically filled at 100%]×100

The filling rate of the electrolyte membrane of the present invention is suitably, for example, 18 to 33%, preferably 30 to 70% and more preferably 40 to 55%. As a result of increasing the filling rate in this manner, the amounts of bound water and free water contained in the electrolyte can be reduced.

### (3) Membrane-Electrode Assembly

A membrane-electrode assembly of the present invention contains the above-mentioned electrolyte membrane, and an electrode provided on at least one side, and usually on both sides, of this electrolyte membrane.

### (3-1) Electrode

An electrode of the present invention has a gas diffusion layer, and a catalyst layer provided on and/or within this gas diffusion layer.

### (3-1-1) Gas Diffusion Layer

A known base having gas permeability such as a carbon fiber woven fabric or carbon paper can be used for the gas diffusion layer. A gas diffusion layer in which these bases are subjected to water repellency treatment is preferable. Water repellency treatment is carried out by, for example, immersing these bases in an aqueous solution of a water repellent containing a fluororesin such as polytetrafluoroethylene or a tetrafluoroethylene-hexafluoropropylene copolymer followed by drying and baking.

### (3-1-2) Catalyst Layer

Suitable examples of catalytic substances used in the catalyst layer include platinum group metals such as platinum, rhodium, ruthenium, iridium, palladium, osmium and alloys thereof. These catalytic substances and salts thereof may be used alone or as a mixture thereof. Metal salts and complexes, and particularly amine complexes represented by [Pt(NH₃)₄]X₂ or [Pt(NH₃)₀]X₄ (wherein, X represents a monovalent anion) are preferable. In addition, in the case of using a metal compound for the catalyst, a mixture of several compounds may be used or the metal compound may be used in the form of a double salt. For example, in the case of using a mixture of a platinum compound and a ruthenium compound, a platinum-ruthenium alloy can be expected to be formed by a reduction step.

Although there are no limitations on the particle diameter of the catalyst, from the viewpoint of a suitable size for increasing catalyst activity, a mean particle diameter of 0.5 to 20 nm is preferable. Furthermore, according to research conducted by K. Kinoshita et al. (J. Electrochem. Soc., 137, 845 (1990)), the particle diameter of platinum that yields the highest level of activity for reduction of oxygen is reported to be about 3 nm.

A co-catalyst can be further added to the catalyst used in the present invention. An example of a co-catalyst is carbon fine powder. Carbon fine powder that allows the catalyst with which it is used to demonstrate a high level of activity is preferable, and in the case of, for example, using a compound of a platinum family metal for the catalyst, acetylene black such as Denka Black, Valcan Black XC-72 or Black Pearl 2000 is preferable. Although varying according to the adhesion method and so on, the amount of the catalyst is suitably adhered within the range of, for example, about 0.02 to 20 mg/cm² and preferably about 0.02 to 20 mg/cm² to the surface of the gas diffusion layer. In addition, it is suitable present at, for example, 0.01 to 10% by weight and preferably 0.3 to 5% by weight based on the total weight of the electrode.

### (3-1-3) Binder

The electrode preferably has a binder with in and/or on the surface thereof. Such a binder promotes bonding between the electrode and electrolyte membrane in the case of using with the above-mentioned diffusion layer and catalyst layer. Examples of binders that can be used include all of the polymers able to be used in the present invention as well as fluorine-based and other solid polymer electrolytes such as Nafion® or Flemion®.

### (3-1-4) Electrode Properties

The resulting electrode is porous. The mean pore diameter f this porous electrode is suitably, for example, 0.01 to 50 μm and preferably 0.1 to 40 μm. Moreover, the porosity of this porous electrode is suitably, for example, 10 to 99% and preferably 10 to 60%.

### (3-2) Production of Membrane-Electrode Assembly

A membrane-electrode assembly of the present invention is produced by providing the above-mentioned electrode on the electrolyte membrane. Preferably, the catalyst layer side of the electrode is joined to the electrolyte membrane. Examples of processes for producing this membrane-electrode assembly include the three processes described below.

(a) In this process, a catalyst layer is formed on the electrolyte membrane by directly applying a catalytic substance, and a gas diffusion layer is further formed on the formed catalyst layer. For example, according to the process described in Publication of a Translation of an International Application No. 2000-516014, a catalyst layer is formed by applying a catalytic substance containing a perfluorocarbon polymer having ion exchange groups, a platinum group catalyst, a fine powder carbon (carbon black) and other additives to an electrolyte membrane by coating, spraying or printing, and then heating and pressing a gas diffusion layer on to this catalyst layer by hot-pressing.

(b) In this process, a catalyst layer is produced in advance by applying a catalytic substance to a substrate, transferring the resulting catalyst layer to an electrolyte membrane and forming a gas diffusion layer on the formed catalyst layer. An example of such a process consists of uniformly mixing polytetrafluoroethylene with platinum black synthesized according to the Thomas process and press-molding by applying to a Teflon® sheet, followed by transferring to an electrolyte membrane, positioning a gas diffusion layer thereon and hot-pressing the resulting laminate.

(c) In this process, an electrode is produced in advance by immersing a gas diffusion layer in a solution of a catalytic substance followed by providing the resulting electrode on an electrolyte membrane. For example, this process consists of immersing a gas diffusion layer in a solution (paste) of a soluble platinum group salt, and adsorbing (ion exchange) the soluble platinum group salt on and into the gas diffusion layer. Next, the gas diffusion layer is immersed in a solution of a reducing agent such as hydrazine or Na₂BO₄ to precipitate metal serving as a catalyst on the gas diffusion layer.

A more preferable example of a process for producing the membrane-electrode assembly of the present invention consists of applying an electrode material comprising a catalytic substance and a gas diffusion layer material directly to an electrolyte membrane More specifically, a paste is produced by using catalyst-loaded carbon particles loaded with a catalytic substance such as platinum-ruthenium (Pt—Ru) or platinum (Pt) for the catalytic substance, and mixing this catalytic substance with a solvent such as water, an adhesive such as a solid polymer electrolyte and, arbitrarily, a water repellent such as polytetrafluoroethylene (PTFE) particles used in the production of a gas diffusion layer. This paste is then applied directly to the electrolyte membrane of the present invention by coating or spraying followed by heating and drying to form a catalyst layer (containing a water repellent layer serving as a portion of the gas diffusion layer in the case of containing a water repellent) on the polymer electrolyte. An electrode is then produced by hot-pressing a gas diffusion layer such as carbon paper arbitrarily subjected to water repellency treatment onto this catalyst layer.

The thickness of the catalyst layer at this time is suitably, for example, 0.1 to 1000 preferably 1 to 500 μm and more preferably 2 to 50 μm.

The above-mentioned paste preferably has the viscosity thereof adjusted to be within the range of 0.1 to 1000 Pa·s. This viscosity can be adjusted by (i) selecting each particle size, (ii) adjusting the composition of the catalyst particles and binder composition, (iii) adjusting the water content, or (iv) preferably adding a viscosity adjuster such as carboxymethyl cellulose, methylcellulose, hydroxyethyl cellulose or cellulose, and polyethylene glycol, polyvinyl alcohol, polyvinyl pyrrolidone, sodium polyacrylate or polymethyl vinyl ether.

### (4) Fuel Cell

A fuel cell of the present invention uses the above-mentioned membrane-electrode assembly. Examples of the fuel cell of the present invention include polymer electrolyte fuel cells (PEFC) and direct methanol fuel cells (DMFC).

In addition, the production process of the fuel cell of the present invention includes a step in which a electrolyte-electrode assembly is obtained by arranging the above-mentioned electrolyte membrane between two electrodes.

More specifically, for example, a catalyst layer is adhered to each side of the electrolyte membrane of the present invention, two electrodes consisting of an anode and cathode are arranged or interposed on each side of the membrane-electrode assembly further provided with a gas diffusion layer, a fuel chamber capable of retaining non-pressurized or pressurized hydrogen gas, pressurized methanol gas or a methanol solution is arranged on one side of the resulting laminate, and a gas chamber capable of retaining non-pressurized or pressurized oxygen or air is arranged on the other side of the laminate to produce a fuel cell. A fuel cell produced in this manner acquires electrical energy from a reaction between the hydrogen or methanol and oxygen.

In addition, with the membrane-electrode assemblies or laminates being a unit, a large number of these membrane-electrode assemblies or laminates may also be arranged in series or parallel to acquire a required electrical power.

### EXAMPLES

Although the following provides a more detailed explanation of the present invention through examples thereof, the present invention is not limited to these examples.

### Example 1

37.247 g of 4,4′-dihydroxybiphenyl, 40.208 g of bis(4-chlorophenyl)sulfone, 30.558 g of 4,4′-dihydroxy-3,3′-disulfonic acid diphenylsulfone sodium salt, 33.17 g of potassium carbonate and 250 ml of dimethylacetoamide were charged into a 500 ml volume round-bottom, four-mouth flask equipped with a Dean-Stark trap, condenser, stirrer and nitrogen feed tube. After heating this mixture to 100° C. over an oil bath, 200 ml of toluene were added followed by heating to 160° C. and refluxing for 4 hours to distill off the toluene. In addition to then raising the temperature of the oil bath to 180° C. to distill off the toluene, polymerization was continued for 80 hours at 180° C. After cooling, the solution was poured into 2,500 ml of water to precipitate polymer followed by washing this polymer with water and drying (yield: 99%). The resulting polymer (powder) was then re-dissolved in N-methyl-2-pyrrolidinone to produce a polyethersulfone solution (solid content 20% by weight). In addition, the number average molecular weight as measured using gel permeation chromatography (GPC) was 30,000 (as polystyrene). When the ratio of the carbon (C) and sulfur (S) components of this polymer were determined by elementary analysis (Perkin PE-2400), the EW value was found to be 829 (g·eq⁻¹).

After immersing an adequately degassed porous base material in the form of a polyimide film (tradename: UPILEX-PT, Ube Industries, porosity: 50%, film thickness: 30 μm, mean penetrating pore diameter: 0.35 μm (as measured with a mercury porosi meter)) in N-methyl-2-pyrrolidinone, the film was held therein at 120° C. f or 15 minutes. Following heat treatment, the polyimide film was removed from the N-methyl-2-pyrrolidinone, and this polyimide film was then immersed in the polyethersulfone solution (20% by weight) prepared in the manner described above. Following immersion and after adequately removing any resin adhered to the surface of the porous base material on the surface, the surface was covered with a glass base material followed by heat treating for 5 hours at 130° C. to slowly remove the solvent and fill the pores. As a result of then washing the filled film with water and vacuum-drying for 2 hours at 80° C. to remove the water, sulfonated polyethersulfone (S-PES polymer) was filled into the pores of the polyimide film. Subsequently, the film was adequately washed with water and immersed for 24 hours in a 1 N sulfuric acid solution. Following immersion, the film was dried to obtain an electrolyte membrane of the present invention. Based on the weight of the membrane after filling with the proton-conducting polymer composition, an electrolyte membrane was obtained in which the filling rate per weight of the electrolyte membrane filled into the pores was 30%, and the film thickness was 30 μm.

### Example 2

37.242 g of 4,4′-dihydroxyphenyl, 45.952 g of bis(4-chlorophenyl)sulfone, 20.372 g of 4,4′-dihydroxy-3,3′-disulfonic acid diphenylsulfone sodium, 33.17 g of potassium carbonate and 250 ml of dimethylacetoamide were charged into a 500 ml volume round-bottom, four-mouth flask equipped with a Dean-Stark trap, condenser, stirrer and nitrogen feed tube. After heating this mixture to 100° C. over an oil bath, 200 ml of toluene were added followed by heating to 160° C. and refluxing for 4 hours to distill off the toluene. In addition to then raising the temperature of the oil bath to 180° C. to distill off the toluene, polymerization was continued for 80 hours at 180° C. After cooling, the solution was poured into 2,500 ml of water to precipitate polymer followed by washing this polymer with water and drying (yield: 99%). The resulting polymer (powder) was then re-dissolved in N-methyl-2-pyrrolidinone to produce a polyethersulfone solution (solid content: 20% by weight) In addition, the number average molecular weight as measured using gel permeation chromatography (GPC) was 30,000 (as polystyrene). When the ratio of the carbon (C) and sulfur (S) components of this polymer were determined by elementary analysis (Perkin PE-2400), the EW value was found to be 1163 (g·eq⁻¹).

After immersing an adequately degassed porous base material in the for of a polyimide film (trade name; UPILEX-PT, Ube industries, porosity: 50%, film thickness; 30 μm) in N-methyl-2-pyrrolidinone, the film was held therein at 120° C. for 15 minutes. Following heat treatment, the polyimide film was removed from the N-methyl-2-pyrrolidinone, and this polyimide film was then immersed in the polyethersulfone solution (20% by weight) prepared in the manner described above. Following immersion and after adequately removing any resin adhered to the surface of the porous base material on the surface, the surface was covered with a glass base material followed by heat treating for 5 hours at 130° C. to slowly remove the solvent and fill the pores. As a result of then washing the filled film with water and vacuum-drying for 2 hours at 80° C. to remove the water, sulfonated polyethersulfone (S-PES polymer) was filled into the pores of the polyimide film. Subsequently, the film was adequately washed with water and immersed for 24 hours in a 1 N sulfuric acid solution. Following immersion, the film was dried to obtain an electrolyte membrane of the present invention. Based on the weight of the membrane after filling with the proton-conducting polymer composition, an electrolyte membrane was obtained in which the filling rate per weight of the electrolyte membrane filled into the pores was 30%, and the film thickness was 30 μm.

### Example 3

After immersing an adequately degassed porous base material in the form of a polyimide film (trade name: UPILEX-PT, Ube Industries, porosity: 50%, film thickness; 30 μm) in N-methyl-2-pyrrolidinone, the film was held therein at 120° C. for 15 minutes. Following heat treatment, the polyimide film was removed from the N-methyl-2-pyrrolidinone, and this polyimide film was then immersed in the polyethersulfone solution (solid content: 15% by weight, N-methyl-2-pyrrolidinone solution) prepared in Example 1. The surface of the base material was covered with a glass base material followed by heat treating for 5 hours at 130° C. to slowly remove the solvent. This procedure was then repeated to fill the pores of the porous base material. As a result of subsequently washing the film with water and vacuum-drying for 2 hours at 80° C. to remove the water, sulfonated polyethersulfone (S-PES polymer) was filled into the pores of the polyimide film. Subsequently, the film was adequately washed with water and immersed for 24 hours in a 1 N sulfuric acid solution. Following immersion, the film was dried to obtain an electrolyte membrane of the present invention. Electrolyte membranes of the present invention were produced having the filling rates and film thicknesses shown in Table 1 by changing the number of times filling was repeated.

TABLE 1

| Film thickness (μm) | Filling rate (wt %) |
|---|---|
| 27 | 23 |
| 28 | 31 |
| 22 | 38 |
| 33 | 55 |
| 34 | 83 |

### Example 4

After immersing an adequately degassed porous base material in the form of a polyimide film (trade name: UPILEX-PT, Ube Industries, porosity: 50%, film thickness: 30 μm) in N-methyl-2-pyrrolidinone, the film was held therein at 120° C. for 15 minutes. Following heat treatment, the polyimide film was removed from the N-methyl-2-pyrrolidinone, and this polyimide film was then immersed in the polyethersulfone solution (solid content: 15% by weight, N-methyl-2-pyrrolidinone solution) prepared in Example 2. The surface of the base material was covered with a glass base material followed by heat treating for 5 hours at 130° C. to slowly remove the solvent. This procedure was then repeated to fill the pores of the porous base material. As a result of subsequently washing the film with water and vacuum-drying for 2 hours at 80° C. to remove the water, sulfonated polyethersulfone (S-PES polymer) was filled into the pores of the polyimide film. Subsequently, the film was adequately washed with water and immersed for 24 hours in a 1 N sulfuric acid solution. Following immersion, the film was dried to obtain an electrolyte membrane of the present invention. Electrolyte membranes of the present invention were produced having the filling rates and film thicknesses shown in Table 2 by changing the number of times filling was repeated.

TABLE 2

| Film thickness (μm) | Filling rate (wt %) |
|---|---|
| 23 | 18 |
| 23 | 38 |
| 29 | 51 |
| 28 | 61 |
| 39 | 70 |

### Comparative Example 1

The commercially available Nafion® 117 (film thickness; 175 μm) was used. A porous base material was not used.

### Comparative Example 2

The polyethersulfone solution produced in Example 1 (solid content: 20% by weight) was cast on a glass substrate and spread over the glass substrate followed by drying for 30 minutes at 100° C. and for 1 hour at 160° C. to remove the solvent. Subsequently, the glass substrate was immersed for 24 hours in 1N sulfuric acid solution to obtain an electrolyte membrane having a thickness of 50 μm. Furthermore, a porous base material was not used.

### Comparative Example 3

The polyethersulfone solution produced in Example 2 (solid content: 20% by weight) was cast on a glass substrate and spread over the glass substrate followed by drying for 30 minutes at 100° C. and for 1 hour at 160° C. to remove the solvent. Subsequently, the glass substrate was immersed for 24 hours in 1 N sulfuric acid solution to obtain an electrolyte membrane having a thickness of 50 μm. Furthermore, a porous base material was not used.

<Evaluation>

Sections measuring 2 cm×2 cm were cut out of the resulting electrolyte membranes of the examples and comparative examples and evaluated for rate of change in surface area, oxidation resistance, shape stability, proton conductivity and methanol permeability according to the methods described below.

(i) Proton Conductivity

A strip measuring 10 mm×30 mm was cut from the electrolyte membranes, both ends were sandwiched between platinum plates (5 mm×50 mm) and then clamped with a Teflon® measuring probe. The clamped laminate was placed in an atmosphere at 25° C. and 100% humidity followed by measuring the resistance between the platinum plates with the Solartron 1260 Frequency Response Analyzer and determining proton conductivity from the equation shown below.

Proton conductivity[S/cm]=Distance between platinum plates [cm]/(membrane width[cm]membrane thickness[cm])×resistance[Ω]

The electrolyte membrane was considered to have satisfactory proton conductivity if the proton conductivity was 0.01 Sm⁻¹ or more, and preferably 0.03 Sm⁻¹ or more.

(ii) Methanol Permeability

Methanol permeability was measured according to the method of Yamaguchi et al. (J. Electrochem. Soc., 2002, 149, A1448-1453) using a 30% by weight aqueous methanol solution at 25° C. The amount of methanol that permeated the electrolyte membrane was determined by gas chromatography, and the amount of permeated methanol was plotted with respect to the changeover time. The methanol permeation flow rate J was obtained from the slope of this plot, and the methanol permeation coefficient P was calculated from this methanol permeation flow rate J according to the equation below in consideration of the membrane thickness of the electrolyte membrane.

P=J×1
(P: methanol permeation coefficient (kg·μm/m²h), J: methanol permeation flow rate (kg·m/m²h), l: membrane thickness (μm))

A methanol permeation coefficient P of 50 (kg·μm/m²h) or less was evaluated as [good methanol permeability], while a value of P in excess of 50 (kg·μm/m²h) was evaluated as NG.

(iii) Activation Energy

Activation energy was determined by measuring proton conductivity while changing the measuring temperature in the same manner as (i) above. Absolute temperature T was plotted as 1/T on the horizontal axis of the graph, while proton conductivity s was plotted as the common logarithm Log(s) on the vertical axis to create an Arrhenius plot. Grade G was obtained in the Arrhenius plot, and activation energy E [J/mol] was then calculated from the equation E=−2.302×G×R (wherein, R is a gas constant having a value of 8.314 (J/K·mol) by determining the slope G of the Arrhenius plot.

As activation energy increases, the proton conducting mechanism becomes less dependent on free water and bound water. Namely, in the case of a large activation energy, protons migrate only by sulfonic acid groups. On the other hand, in the case of a small activation energy, protons tend to migrate by free water and bound water contained in the sulfonic acid groups.

(iv) Structural Analysis and Content of Water in Electrolyte

Each electrolyte membrane was immersed in water for 24 hours at 25° C. followed by wiping off water adhered to the surface thereof for use as a sample for low-temperature DSC. The measurement conditions for low-temperature DSC consisted of cooling from 20 to −50° C. at the rate of 20° C./min followed by heating to 20° C. at the rate of 5.0° C./min. The area of the melting endothermic peak of the water during the heating process was analyzed using a baseline of −30 to 10° C. A quantitative analysis was conducted by assigning a sharp melting endothermic peak at 0° C. to free water, and a broad melting endothermic peak at 0° C. or lower to bound water. Following measurement, the samples were vacuum-dried for 4 hours at 90° C. followed by measurement of the dry weight after having removed all of the free water and bound water to determine the total water content. The difference between the amounts of free water and bound water as determined from low-temperature DSC and the total water content was taken to be the amount of non-freezing water. The number of molecules of free water, bound water and non-freezing water per sulfonic acid group were then determined by dividing the amounts of free water, bound water and non-freezing water by the number of sulfonic acid groups in the sample.

<v> The Density of Sulphonic Acid Groups

The density of protonic acid groups (sulphonic acid groups) in S-PES polymer of Examples 1 to 4 were obtained by the following formula.

[Density of Sulphonic acid groups(mmol/cm³)]=[Volume density of Filled polymer(g/cm³)]×[Ion change capacity IEC (meq)]

wherein the volume density of filled polymer (g/cm³) was calculated from the mass (g) of the polymer filled in the pore(s) which has (have) a volume of [1 cm×1 cm×(the film thickness of the filled polymer (cm))×(the porosity after the polymer was filled)]. The results are summarized in Table 3.

TABLE 3

| | Film | | | | |
|---|---|---|---|---|---|
| | thickness | porosity | Mass of | Volume | Density of |
| | of the | after the | the | density of | Suphonic |
| | filled | polymer | filled | Filled | acid |
| | polymer | was filled | polymer | polymer | groups |
| | (cm) | (%) | (g) | (g/cm³) | (mmol/cm²) |
| Ex. 1 | 26 × 10⁻⁴ | 0.39 | 0.61 × 10⁻³ | 0.61 | 0.85 |
| Ex. 2 | 26 × 10⁻⁴ | 0.39 | 1.00 × 10⁻³ | 1.00 | 0.98 |
| Ex. 3 | 26.6 × 10⁻⁴ | 0.40 | 0.72 × 10⁻³ | 0.67 | 0.88 |
| Ex. 4 | 30.8 × 10⁻⁴ | 0.47 | 1.51 × 10⁻³ | 0.99 | 0.96 |

* The values of Examples 3 and 4 are average values of 5 measurement values such as those shown in FIG. 5.

### Comparison of Examples 1 and 2 and Comparative Examples 1 to 3

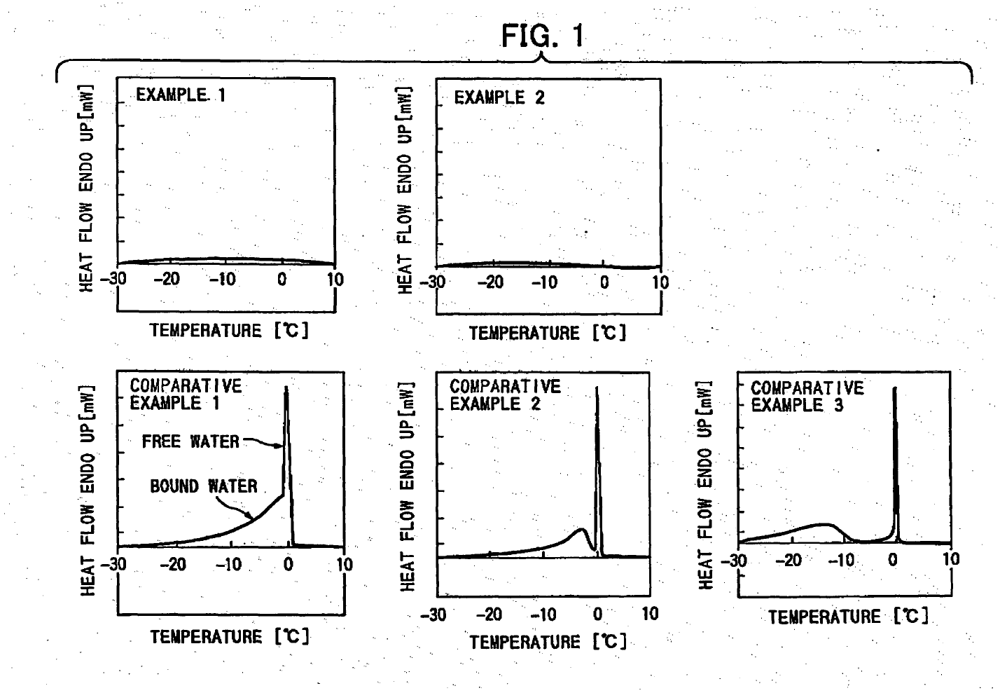

The DSC measurement data is shown in FIG. 1. Peaks were observed for free water and bound water based on the measurement data of Comparative Examples 1, 2 and 3 in FIG. 1. Only slight peaks were observed for bound water based on the measurement data of Examples 1 and 2 in FIG. 1.

The results for water structural analysis and content, proton conductivity, activation energy and methanol permeability (25° C., 30% by weight aqueous methanol solution) are shown in Table 4. Examples 1 and 2 were determined to contain hardly any free water and only an extremely small amount of bound water as compared with Comparative Examples 1, 2 and 3. Moreover, Examples 1 and 2 demonstrated proton conductivity even at free water and bound water levels of 0 and 0.5 or less, respectively, and methanol permeability was found to be able to be inhibited considerably. In addition, calculation of Arrhenius plots revealed Examples 1 and 2 to have high activation energy. Examples 1 and 2 are presumed to have a different proton conducting mechanism as compared with that of Comparative Examples 1, 2 and 3.

TABLE 4

| | Numbers of free water, | | | | | |
|---|---|---|---|---|---|---|
| | bound water and | | | | | |
| | non-freezing water | | | | | |
| | molecules per sulfonic | | | | | |
| | acid group | | | | | |
| | | | Non- | Proton | Activation | Methanol |
| | Free | Bound | freezing | conductivity | energy | permeability |
| | water | water | water | (S/cm) | (kJ/mol) | (kg · μm/m² · h) |
| Example 1 | 0 | 0.2 | 7.8 | 2.5 × 10⁻³ | 13.9 | 0.668 |
| Example 2 | 0 | 0.2 | 11.7 | 1.3 × 10⁻³ | 14.9 | 2.363 |
| Comparative | 2.1 | 11.4 | 8.4 | 8.0 × 10⁻² | 11 | 330 |
| Example 1 | | | | | | |
| Comparative | 3.1 | 10.1 | 6.9 | 9.3 × 10⁻² | 9.8 | 55.4 |
| Example 2 | | | | | | |
| Comparative | 1.3 | 4.1 | 10.9 | 5.7 × 10⁻² | 9.8 | 20.2 |
| Example 3 | | | | | | |

<Evaluation Results of Examples 3 and 4>

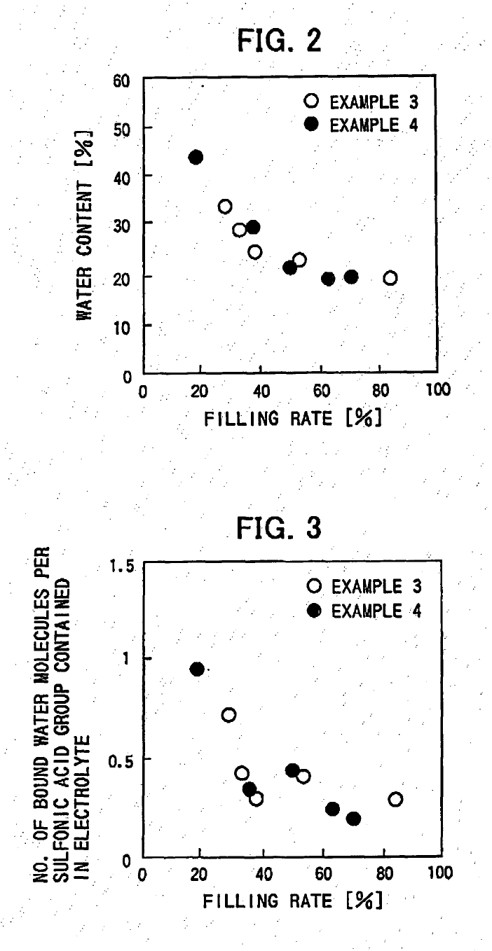

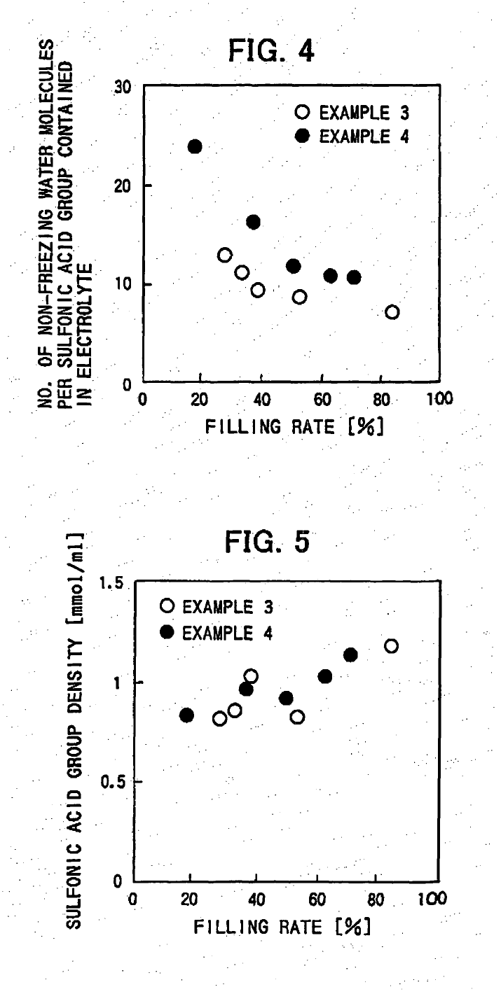

The relationship between filling rate and water content is shown in FIG. 2, the relationship between filling rate and number of bound water molecules is shown in FIG. 3, the relationship between filling rate and number of non-freezing water molecules is shown in FIG. 4, and the relationship between filling rate and sulfonic acid group density is shown in FIG. 5 for electrolyte membranes produced in Examples 3 and 4 having different filling rates. As filling rate increases, the water content, number of bound water molecules and number of non-freezing water molecules tends to decrease. This is thought to be due to the water content, number of bound water molecules and number of non-freezing water molecules having decreased as a result of swelling of the resin being inhibited by filling the pores. In addition, water content was determined using the equation shown below.

[Water content(%)]=100×([swollen membrane weight]−[dry membrane weight])/[dry membrane weight]

Furthermore, the swollen membrane weight was determined after having immersed the membrane in the manner previously described and adequately wiping off the membrane surface.

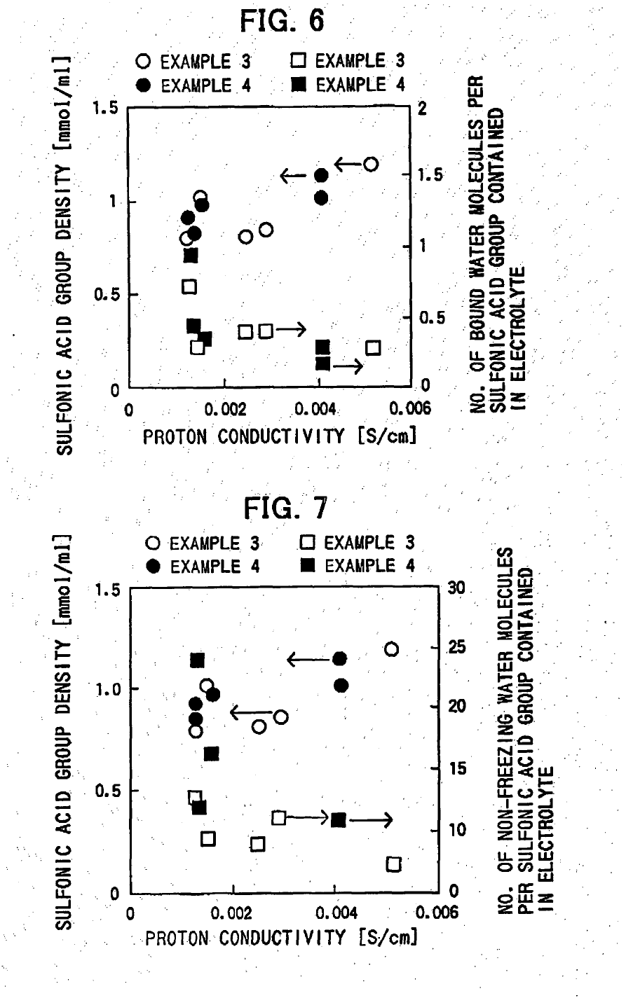

The relationship between proton conductivity and sulfonic acid group density and the number of bound water molecules of the electrolyte membranes produced in Examples 3 and 4 is shown in FIG. 6, while the relationship between proton conductivity and sulfonic acid group density and the number of non-freezing water molecules is shown in FIG. 7. Based on these graphs, in the case of the electrolyte membrane of the present invention, sulfonic acid group density was found to have an effect on proton conductivity, and proton conductivity was determined to not decrease even if the number of non-freezing water molecules per sulfonic acid group contained in the electrolyte membranes was 0.5 molecules or less.

Namely, as can be understood from the results of Examples 3 and 4, since proton conductivity is not affected by water, but rather is affected by the sulfonic acid groups, it is presumed that proton conductivity takes place by a mechanism in which protons migrate via sulfonic acid groups (proton hopping).

Moreover, the water contents of the electrolyte membranes when immersed in water and the rates of change in surface area at that time were determined for the electrolyte membranes of Examples 1 and 2 and Comparative Examples 1 to 3. More specifically, each electrolyte membrane was immersed in pure water for 24 hours at 25° C. followed by measurement of the change in surface area before and after immersion to determine the rate of change in surface area using the equation shown below.

[Rate of change in surface area(%)]100×([surface area of swollen membrane]−[surface area of dry membrane])/(surface area of dry membrane]

In addition, water content was determined using the equation shown below.

[Water content(%)]=100×([swollen membrane weight]−[dry membrane weight])/[dry membrane weight]

Furthermore, the swollen membrane weight was determined after having immersed the membrane in the manner previously described and adequately wiping off the membrane surface. The results are summarized in Table 5.

TABLE 5

| | Rate of change in | Water |
|---|---|---|
| | surface area (%) | content (%) |
| Example 1 | <1 | <10 |
| Example 2 | <1 | <8 |
| Comparative Example 1 | 25 | 35 |
| Comparative Example 2 | 30 | 30 |
| Comparative Example 3 | 30 | 30 |

On the basis of these results, the electrolyte membranes of Examples 1 and 2 were found to have a low water content, and swelling caused by electrolyte solution was determined to be suitably inhibited.

What is claimed is:

1. An electrolyte membrane comprising: a porous base material having a plurality of pores; and a proton-conducting polymer composition retained in said pores, wherein
the proton-conducting polymer composition contains an aromatic hydrocarbon resin having protonic acid groups, free water contained in the electrolyte membrane at 25° C. is present at 0.5 molecules or less per each of the protonic acid groups, bound water contained in the electrolyte membrane at 25° C. is present at 1 molecule or less for each of the protonic acid groups, proton conductivity of the electrolyte membrane in water at 25° C. is 0.001 S/cm or more, and methanol permeability of the electrolyte membrane in 30% by weight methanol at 25° C. is 50 (kg·μm/m²·h) or less.

2. The electrolyte membrane according to claim 1, wherein the aromatic hydrocarbon resin is selected from the group consisting of polysulfone, polyethersulfone, polyarylate, polyamideimide, polyetherimide, polyimide, polyquinoline and polyquinoxaline.

3. The electrolyte membrane according to claim 1, wherein the aromatic hydrocarbon resin is polyethersulfone.

4. The electrolyte membrane according to claim 1, wherein the protonic acid groups are selected from the group consisting of sulfonic acid groups, carboxylic acid groups, phosphoric acid groups and phenolic hydroxyl groups.

5. The electrolyte membrane according to claim 1, wherein the aromatic hydrocarbon resin contains the structure represented by general formula (I): 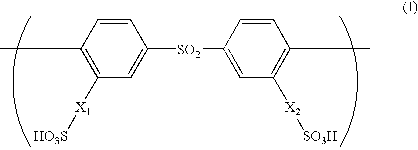
(wherein, X₁ and X₂ may be mutually the same or different, and represent —(ROₘ)ₙ—, and wherein R represents an alkylene group, m represents 0 or 1, and n represents an integer of 0 to 2).

6. The electrolyte membrane according to claim 1, wherein the porous base material is an inorganic material or a heat-resistant polymer.

7. The electrolyte membrane according to claim 1, wherein the porous base material is polyimide, and the aromatic hydrocarbon resin is polyethersulfone.

8. The electrolyte membrane according to claim 1, wherein the proton-conducting polymer composition contains a crosslinking agent.

9. The electrolyte membrane according to claim 1, wherein a portion of the pores and a portion of the aromatic hydrocarbon resin are immobilized.

10. A method for producing the electrolyte membrane according to claim 1 having a porous base material having a plurality of pores and a proton-conducting polymer composition retained in said pores, comprising the steps of:
(1) retaining a monomer and/or oligomer for forming the proton-conducting polymer composition in the pores of the porous base material; and
(2) polymerizing the monomer and/or the oligomer in the pores.

11. The method for producing an electrolyte membrane according to claim 10, wherein the monomer and/or oligomer for forming the proton-conducting polymer composition has three or more reactive groups.

12. A method for producing the electrolyte membrane according to claim 1 having: a porous base material having a plurality of pores; and a proton-conducting polymer composition retained in said pores, the process comprising the steps of;
(1) introducing the proton-conducting polymer composition into the pores of the porous base material by immersing the porous base material in a solvent solution of the proton-conducting polymer composition; and
(2) holding the porous base material retaining the proton-conducting polymer composition at a temperature of 60° C. or higher for at least 1 hour.

13. A membrane-electrode assembly using the electrolyte membrane according to claim 1.

14. A fuel cell using the membrane-electrode assembly according to claim 13.
